(19) United States
(12) Patent Application Publication
(10) Pub. No.: US 2024/0104281 A1
(43) Pub. Date: Mar. 28, 2024

(54) DESIGN ASSIST DEVICE AND DESIGN ASSIST PROGRAM

(71) Applicant: OMRON Corporation, Kyoto-shi, KYOTO (JP)

(72) Inventors: Liangyu SHEN, Kyoto-shi, KYOTO (JP); Takeshi KIRIBUCHI, Kyoto-shi, KYOTO (JP); Takeshi ASHIDA, Kyoto-shi, KYOTO (JP); Hiroyuki TOKUSAKI, Kyoto-shi, KYOTO (JP); Masashi DOI, Kyoto-shi, KYOTO (JP)

(21) Appl. No.: 18/254,083

(22) PCT Filed: Sep. 14, 2021
(86) PCT No.: PCT/JP2021/033778

§ 371 Date: May 23, 2023

(30) Foreign Application Priority Data
Dec. 23, 2020 (JP) 2020-213974

(51) Int. Cl. G06F 30/367

(52) U.S. Cl. CPC G06F 30/367; G06F 2119/06

(57) ABSTRACT

A design assist device assists with designing of a power supply system to supply and distribute power from a power supply and a capacitor connected parallel to each other to a plurality of load devices through a power supply path combining a plurality of power cables. The design assist device includes a calculator and an outputter. The calculator calculates time-series data about a current flowing through the capacitor based on configuration information representing an overall configuration of the power supply path and operation pattern information representing an operation pattern of each of the plurality of load devices, and calculates, based on the time-series data about the current, a recommended capacitance being a capacitance recommended for the capacitor. The outputter outputs at least information about the recommended capacitance for the capacitor.

### FIELD

The present invention relates to a design assist device and a design assist program.

### BACKGROUND

Known systems for supplying power from a single power supply to multiple load devices include systems below.

A system connects multiple load devices in a daisy chain to power cables, with one of the load devices connected to the power supply with a power cable (daisy chain connection system).

A system connects a power supply to multiple load devices to a power supply path branching from the power supply by combining multiple power cables (tree connection system).

Patent Literature 1 describes a technique for displaying a maximum current to flow through each power cable and recommended cable diameters (power cables recommended for use) based on time-series data about the current flowing through multiple load devices in these systems. Thus, users can select power cables appropriate for these systems.

In a known system including a single power supply that supplies power to multiple load devices, a single direct current (DC) power supply and a capacitor are connected in parallel to reduce momentary voltage rises and voltage drops in the multiple load devices caused by, for example, insufficient capacitances of capacitors in the load devices.

### CITATION LIST

### Patent Literature

Patent Literature 1: Japanese Unexamined Patent Application Publication No. 2020-95573

### SUMMARY

### Technical Problem

In this case, capacitors with a less capacitance are smaller. Such a system may include smaller capacitors with an appropriately selected capacitance. The entire system may thus be smaller. However, the technique described in Patent Literature 1 simply allows display of information such as the maximum current flowing through each power cable and the recommended cable diameter. Thus, the above system including the single DC power supply and the capacitor connected in parallel with the technique described in Patent Literature 1 may not allow selection of an appropriate capacitance for the capacitor.

In response to the above issue, one or more aspects of the present invention are directed to a technique for allowing designing of a power supply system that supplies and distributes power from a power supply and a capacitor connected parallel to each other to multiple load devices using a capacitor with appropriate specifications.

### Solution to Problem

A design assist device according to one aspect of the present invention is a design assist device for assisting with designing of a power supply system to supply and distribute power from a power supply and a capacitor connected parallel to each other to a plurality of load devices through a power supply path combining a plurality of power cables. The design assist device includes a first obtainer that obtains configuration information representing an overall configuration of the power supply path, a second obtainer that obtains operation pattern information representing an operation pattern of each of the plurality of load devices, a calculator that calculates time-series data about a current flowing through the capacitor based on the configuration information obtained by the first obtainer and the operation pattern information about each of the plurality of load devices obtained by the second obtainer, and calculates, based on the time-series data about the current, a recommended capacitance being a capacitance recommended for the capacitor, and an outputter that outputs at least information about the recommended capacitance for the capacitor.

This structure allows calculation of an appropriate recommended capacitance reflecting a current flowing through the capacitor. The information about the recommended capacitance is output to inform the user of the recommended capacitance. Thus, the user can design a power supply system using a capacitor with appropriate specifications. This reduces the size and the cost of the power supply system and the capacitor. The configuration information is information about all power cables included in the power supply system, or more specifically, information about the number of power cables and connections between power cables, and information about each power cable (the length and the internal resistance).

In the above design assist device, the power supply system may include the power supply being a direct current power supply, and the plurality of load devices each including a load machine, an electric motor that drives the load machine, and an inverter that controls the electric motor. The second obtainer may obtain a set of command values to be input into the inverter in chronological order as the operation pattern information about each of the plurality of load devices when each of the plurality of load devices is operated. The calculator may generate time-series data about the current flowing into each of the plurality of load devices based on the operation pattern information about each of the plurality of load devices and calculate the time-series data about the current flowing through the capacitor based on the time-series data generated for each of the plurality of load devices and the configuration information. Thus, the time-series data about the current flowing through each load device and the time-series data about the current flowing through the capacitor can be obtained based on the operation pattern and the configuration information, allowing appropriate calculation of the current in the capacitor when the current in the load devices and the capacitor cannot be measured directly.

In the above design assist device, the calculator may calculate at least one of a maximum value of a current flowing from the capacitor or a maximum value of a current flowing into the capacitor as a maximum current value of the capacitor based on the time-series data for each of the plurality of load devices and the configuration information, and calculate the recommended capacitance for the capacitor based on the time-series data about the current flowing through the capacitor and the maximum current value. Thus, the recommended capacitance can be calculated appropriately to reflect voltage drops in multiple load devices due to the maximum level of a current (specifically, reflecting power consumption outside the capacitor).

In the above design assist device, the calculator may calculate, as an electric charge quantity recommended for the capacitor, an integrated value of a current in a predetermined period based on the time-series data about the current flowing through the capacitor, and calculate the recommended capacitance for the capacitor as the electric charge quantity divided by a difference between an allowable voltage and an initial voltage of the capacitor. The allowable voltage may be a voltage value in a range of voltage variation allowable for the capacitor to maintain the operation pattern of each of the plurality of load devices. This allows calculation of an electric charge quantity to be used for the capacitor based on the current flowing through the capacitor, and thus more appropriate calculation of a recommended capacitance.

In the above design assist device, the calculator may calculate an integrated value of a current flowing into the capacitor or an integrated value of a current flowing from the capacitor in the predetermined period as the electric charge quantity. Thus, either the current flowing from the capacitor (power-running current) or the current flowing into the capacitor (regenerative current) is used as the recommended electric charge quantity when either the capacitor or the power supply can supply most of the power to calculate an appropriate recommended capacity.

In the above design assist device, the calculator may calculate the recommended capacitance as the electric charge quantity divided by a difference between a lowest value or a highest value of the range of voltage variation allowable for the capacitor and the initial voltage of the capacitor.

In the above design assist device, the calculator may calculate the recommended capacitance as the electric charge quantity divided by a difference between the lowest value of the range of voltage variation allowable for the capacitor and the initial voltage of the capacitor when the electric charge quantity is positive, and calculate the recommended capacitance as the electric charge quantity divided by a difference between the highest value of the range of voltage variation allowable for the capacitor and the initial voltage of the capacitor when the electric charge quantity is negative. This allows calculation of an appropriate recommended capacity when the current flowing from the capacitor (power-running current) is larger than the current flowing into the capacitor (regenerative current).

In the above design assist device, the calculator may calculate an integrated value of a current flowing into the capacitor and an integrated value of a current flowing from the capacitor in the predetermined period, and calculate the recommended capacitance for the capacitor using a greater value of the integrated value of the current flowing into the capacitor divided by the difference between the highest value of the range of voltage variation allowable for the capacitor and the initial voltage of the capacitor, or the integrated value of the current flowing from the capacitor divided by the difference between the lowest value of the range of voltage variation allowable for the capacitor and the initial voltage of the capacitor. This allows more appropriate calculation of a recommended capacitance as appropriate for the relationship between the current flowing from the capacitor (power-running current) and the current flowing into the capacitor (regenerative current).

In the above design assist device, the plurality of load devices may operate cyclically. The predetermined period may be a period of a cycle of an operation of the plurality of load devices or a partial period of the cycle. This allows calculation of an electric charge quantity estimated for the capacitor in one cycle based on the level of a cyclically varying current and allows more appropriate calculation of a recommended capacitance. The integrated value of the current over a partial period of one cycle is also used as the recommended electric charge quantity to allow, for example, the system to be designed to cause power to be supplied from the capacitor when multiple load devices momentarily use power. This reduces the capacitance of the capacitor and thus reduces the size of the capacitor.

In the above design assist device, the plurality of power cables may include a first power cable commonly connecting the plurality of load devices to the capacitor. The calculator may calculate the allowable voltage based on a voltage generated by an internal resistance of the first power cable. This allows calculation of the recommended capacitance for the capacitor reflecting power consumption using the power cable commonly connecting the plurality of load devices to the capacitor, causing neither overvoltage nor undervoltage to occur when the power consumption is large.

In the above design assist device, the calculator may calculate the allowable voltage based on a voltage generated by an internal resistance of each of the plurality of power cables. In a power supply system as a distributed system, the recommended capacitance for the capacitor can be calculated to reflect the power consumption of each power cable to cause neither overvoltage nor undervoltage.

In the above design assist device, the outputter may suggest, to a user, using a branch connector incorporating the capacitor to distribute and supply power to each of the plurality of load devices from the power supply and the capacitor. This allows the branch connector to serve as a capacitor and to distribute the current, thus reducing the size of the power supply system.

A design assist program according to one aspect of the present invention causes a computer to operate as any of the above design assist devices. The design assist program allows designing of a power supply system using a capacitor with appropriate specifications.

One or more aspects of the present invention may be directed to an apparatus including at least one of the above elements of the design assist device, or to a design assist system or an electronic device. One or more aspects of the present invention may also be directed to a control method or a design assist method for a design assist device including at least one of the above processes.

### Advantageous Effects

The technique according to the above aspects of the present invention allows designing of a power supply system that supplies and distributes power from a power supply and a capacitor connected parallel to each other to multiple load devices using a capacitor with appropriate specifications.

### BRIEF DESCRIPTION OF THE DRAWINGS

FIG. 1 is a block diagram of a design assist device according to an embodiment of the present invention.

FIG. 2 is a schematic diagram of an example power supply system to be designed using the design assist device.

FIG. 3A is a schematic diagram of an example power supply path in the power supply system.

FIG. 3B is a schematic diagram of an example power supply path in the power supply system.

FIG. 3C is a schematic diagram of an example power supply path in the power supply system.

FIG. 3D is a schematic diagram of an example power supply path in the power supply system.

FIG. 4 is a flowchart of a design assist process.

FIG. 5 is a graph describing a procedure for generating time-series current data.

FIG. 6 is a timing chart describing currents flowing through load devices and a capacitor in the power supply system in FIG. 2.

FIG. 7 is a timing chart describing a method for calculating an electric charge quantity of the capacitor based on the time-series current data.

FIG. 8 is a diagram describing a design assist process in a modification.

### DETAILED DESCRIPTION

Embodiments of the present invention will now be described with reference to the drawings.

[Configuration of Design Assistance Device]

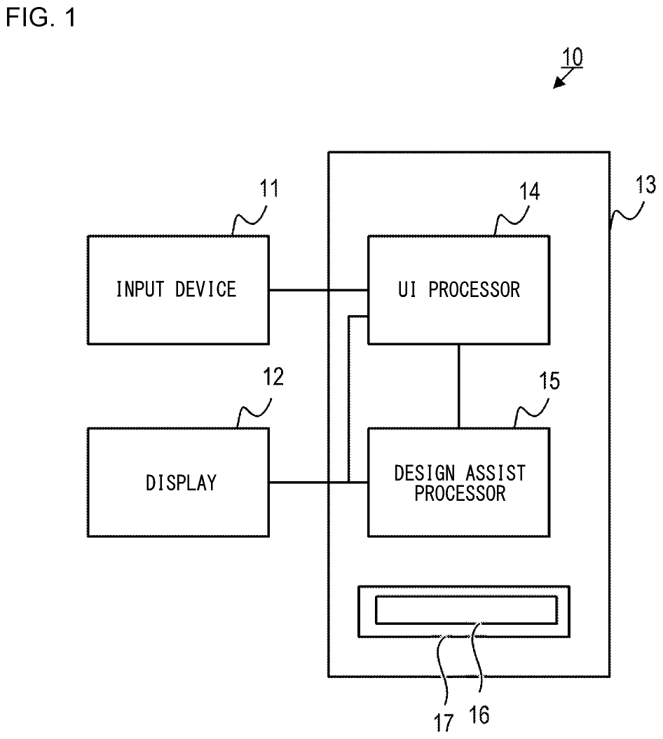

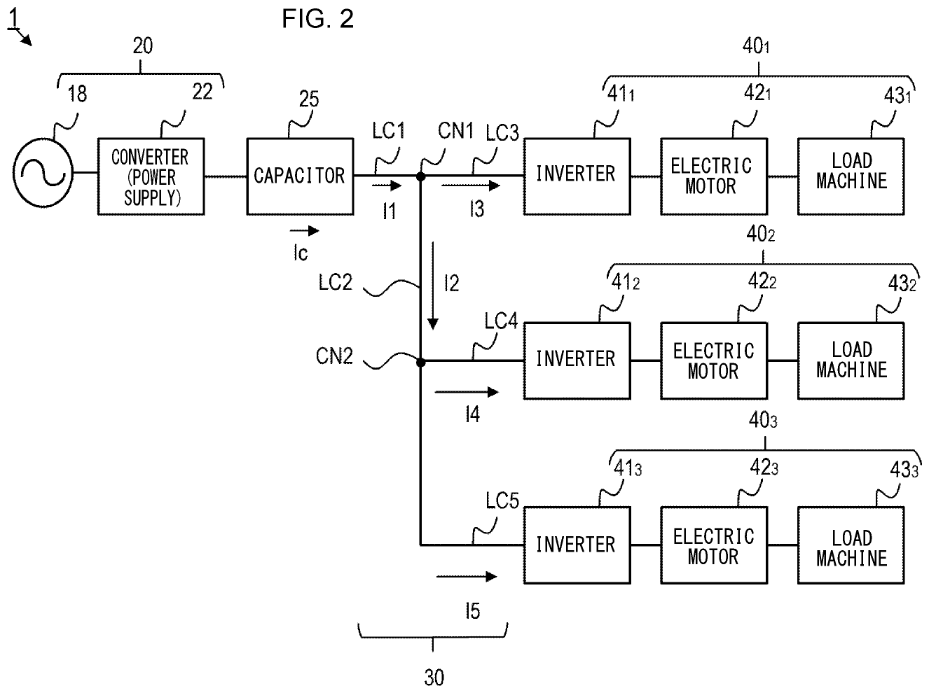

FIG. 1 is a block diagram of a design assist device 10 according to an embodiment of the present invention. The design assist device 10 is designed to assist with designing of a power supply system 1 (servo system) as shown in FIG. 2. Although each connection between components in the power supply system 1 is schematically illustrated as a single cable (power cable) in FIG. 2, each cable includes two lines in the actual system. An electrical current (power) is input into and output from each component with the two lines.

The design assist device 10 is any information processing device that can process information, such as a personal computer (PC) or a server. The design assist device 10 includes an input device 11, such as a keyboard and a mouse, a display 12, and a main unit 13. A user can set (input) information about the structure of the power supply system 1 by operating the input device 11. The display 12 may be any display device that can display images, such as a liquid crystal display or a projector.

The main unit 13 includes, for example, a central processing unit (CPU), a random-access memory (RAM), and a nonvolatile memory device (e.g., a hard disk drive or a solid-state drive) 17. A design assist program 16 is installed in the nonvolatile memory device 17 in the main unit 13. The CPU loads and executes the design assist program 16 on the RAM. The main unit 13 operates as a user interface (UI) processor 14 and a design assist processor 15.

(Configuration of Power Supply System)

The power supply system 1 to be designed using the design assist device 10 will now be described with reference to FIG. 2 before the functions of the UI processor 14 and the design assist processor 15 are described.

In the power supply system 1, power is supplied and distributed from a power supply 20 and a capacitor 25 connected parallel to each other to multiple (three in FIG. 2) load devices 40 through a power supply path 30 combining multiple link cables LC. The power supply system 1 also includes, as the power supply 20, a converter 22 (specifically, a direct current or DC power supply) that converts power from a grid 18 to DC power. The power supply system 1 includes load devices 40_{X} (X=1, 2, 3) each including a load machine 43_{X}, an electric motor 42_{X} (motor), and an inverter 41_{X}. The inverter 41_{X} controls the electric motor 42_{X} with alternating current (AC) power with a frequency used by the electric motor 42_{X} generated from the input power. The electric motor 42_{X} drives the load machine 43_{X} by converting power (electrical energy) to mechanical energy (torque).

The capacitor 25 is an external capacitor attachable to and detachable from the power supply system 1. The capacitor 25 is connected parallel to the power supply 20, and combines with the power supply 20 to supply power to the multiple load devices 40. This maintains a substantially constant voltage applied to the multiple load devices 40, thus reducing the likelihood of sudden (momentary) variation in the voltage applied to the multiple load devices 40 (overvoltage or undervoltage). The capacitor 25 can supply a current (power-running current) to and receive current (regenerative current) from the load devices 40. In the examples described below, Ic is a current flowing through the capacitor 25.

The power supply path 30 includes five link cables (power cables) that are a link cable LC1, a link cable LC2, a link cable LC3, a link cable LC4, and a link cable LC5. The link cable LC1 connects the capacitor 25 to a connector CN1. In other words, the link cable LC1 commonly connects all load devices 40₁ to 40₃ to the capacitor 25. The link cable LC2 connects the connector CN1 to a connector CN2. The link cable LC3 connects the connector CN1 to the load device 40₁. The link cable LC4 connects the connector CN2 to the load device 40₂. The link cable LC5 connects the connector CN2 to the load device 40₃.

Thus, in the power supply path 30, a current I1 flowing through the link cable LC1 is the sum of currents 13 to 15 that flow to the load devices 40₁ to 40₃. A current 12 flowing through the link cable LC2 is the sum of currents 14 and 15 that flow to the load devices 40₂ and 40₃. The power supply path 30 in the power supply system 1 is not limited to the power supply path 30 shown in FIG. 2, but may be any path that distributes a current from the power supply 20 and the capacitor 25 to the load devices 40.

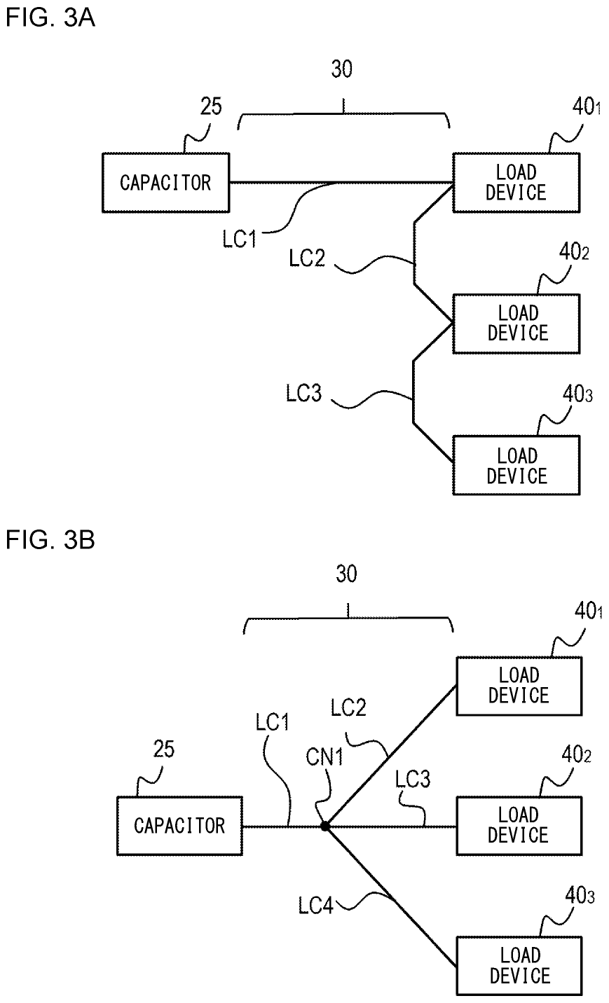

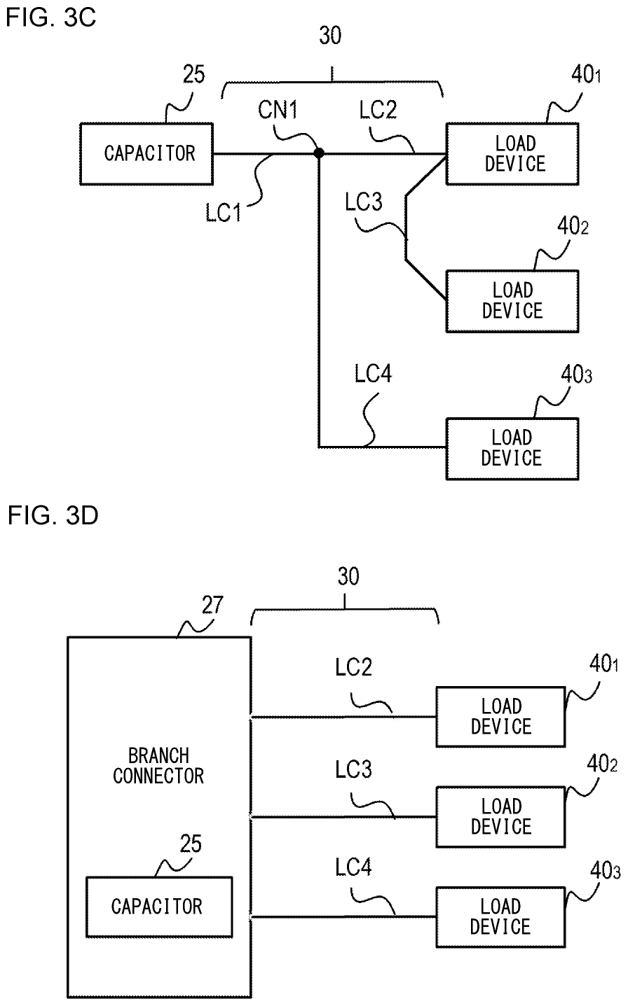

The power supply path 30 may include the link cable LC1 connecting the power supply 20 to the load device 40₁ and the link cables LC2 and LC3 connecting the load devices 40₁ to 40₃ in a daisy chain as shown in FIG. 3A. As shown in FIG. 3B, the power supply path 30 may include the link cable LC1 connecting the power supply 20 to the connector CN1, and the link cables LC2, LC3, and LC4 connecting the link connector CN1 to the corresponding load devices 40₁, 40₂, and 40₃.

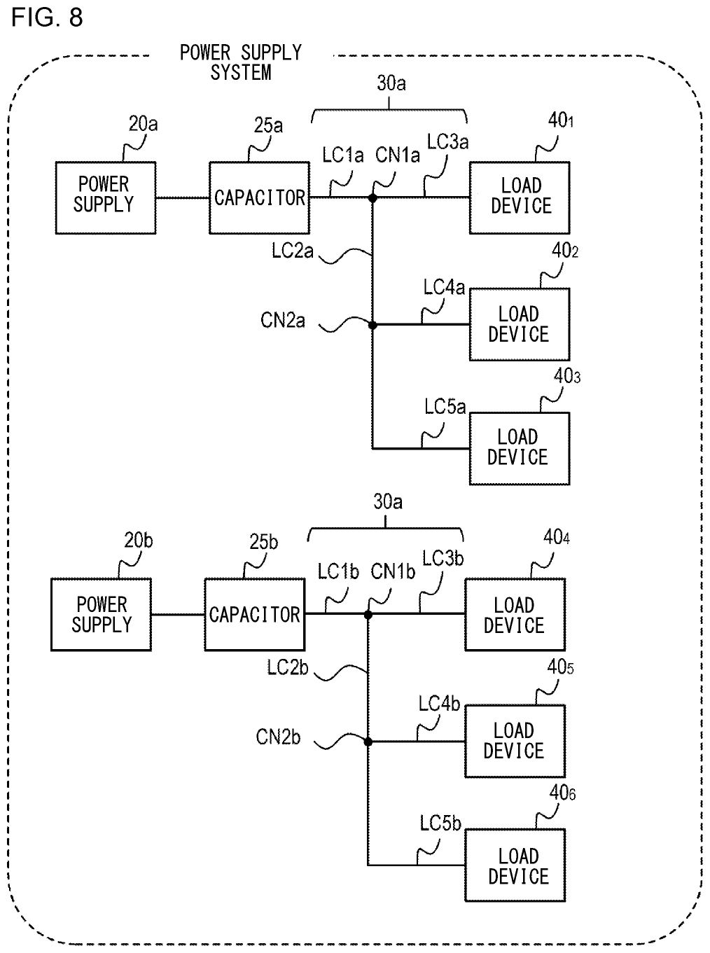

As shown in FIG. 3C, the power supply path 30 may include the link cable LC1 connecting the power supply 20 to the connector CN1, the link cables LC2 and LC4 connecting the link connector CN1 to the corresponding load device 40₁ and 40₃, and the link cable LC3 connecting the load device 40₁ to the load device 40₂. The power supply system 1 designed using the design assist device 10 may be a power supply system 1 for one of the power supplies in a system that supplies and distributes power from each of the multiple power supplies 20 to the multiple load devices 40 (refer to FIG. 8).

The power supply path 30 may not distribute power from the power supply 20 and the capacitor 25 to the three load devices 40₁ to 40₃. For example, the power supply system 1 may include a branch connector 27 that integrally serves as the capacitor 25, the link cable LC1, and the connector CN1, as shown in FIG. 3D. In the power supply system 1, the branch connector 27 incorporates the capacitor 25, and distributes power from the power supply 20 and the capacitor 25 to each of the three load devices. In other words, as shown in FIG. 3D, the load devices 40₁ to 40₃ may be connected individually to the branch connector 27 (capacitor 25). More specifically, in FIG. 3D, each load device 40 is connected to one of the multiple terminals of the branch connector 27 through a link cable in one-to-one connection.

The structure shown in FIG. 3D with the branch connector 27 incorporating the capacitor 25 reduces the size of the power supply system 1. The branch connector 27 may include any number of terminals, to which any number of load devices 40 may be connectable. The branch connector 27 may be of any type. In other words, these items of information may be defined by the user as intended.

The design assist device 10 (design assist processor 15) may also suggest (recommend or notify), to the user, that the power supply system 1 is to use the branch connector 27 to distribute power from the power supply 20 and the capacitor 25 to the load devices 40₁ to 40₃ to reduce the size of the power supply system 1. For example, the design assist device 10 may indicate, on the display 12, its recommendation to use the branch connector 27. For the capacitor 25 with a size to be incorporated in the branch connector 27, the design assist device 10 may provide such a suggestion when a recommended capacitance C (a capacitance recommended for the capacitor 25) described below is less than a predetermined value.

Based on the above, the functions of the design assist device 10 (the UI processor 14 and the design assist processor 15) according to the present embodiment will now be described with reference to FIG. 1. The power supply system 1 to be designed is hereafter referred to as the system to be designed. The total number of load devices 40 in the system to be designed is N (≥2).

The UI processor 14 obtains configuration information as well as operating pattern information and specification information about each of the load devices 40_{X} (1≤X≤N) in response to a user operation on the input device 11. During the process, the UI processor 14 displays various items of image information on the screen of the display 12.

The configuration information obtained by the UI processor 14 from the user is information about the overall configuration of the power supply path 30 (refer to FIGS. 2 and 3A to 3D) in the system to be designed. More specifically, the configuration information includes information about the number of link cables in the system to be designed and connections between link cables, as well as information about each link cable (e.g., the length and the internal resistance).

The operation pattern information about the load device 40_{X} (1≤X≤N) is a set of command values (e.g., a position command and a speed command) that are to be input into the inverter 41_{X} in the load device 40_{X} in chronological order when the system to be designed is operated. The specification information about the load device 40_{X} is information that can be combined with the operation pattern information about the load device 40_{X} to generate data representing the pattern of temporal change in the current flowing into the load device 40_{X} (hereafter referred to as time-series current data). The UI processor 14 in the design assist device 10 according to the present embodiment is configured (programmed) to obtain, from the user, information about, for example, the inertia and torque constants of the electric motor 42_{X} and the inertia of the load machine 43_{X} as the specification information about the load device 40_{X}. Once the above information is obtained, the UI processor 14 instructs the design assist processor 15 to perform a design assist process in response to an instruction input from the user to perform the design assist process.

[Design Assistance Process]

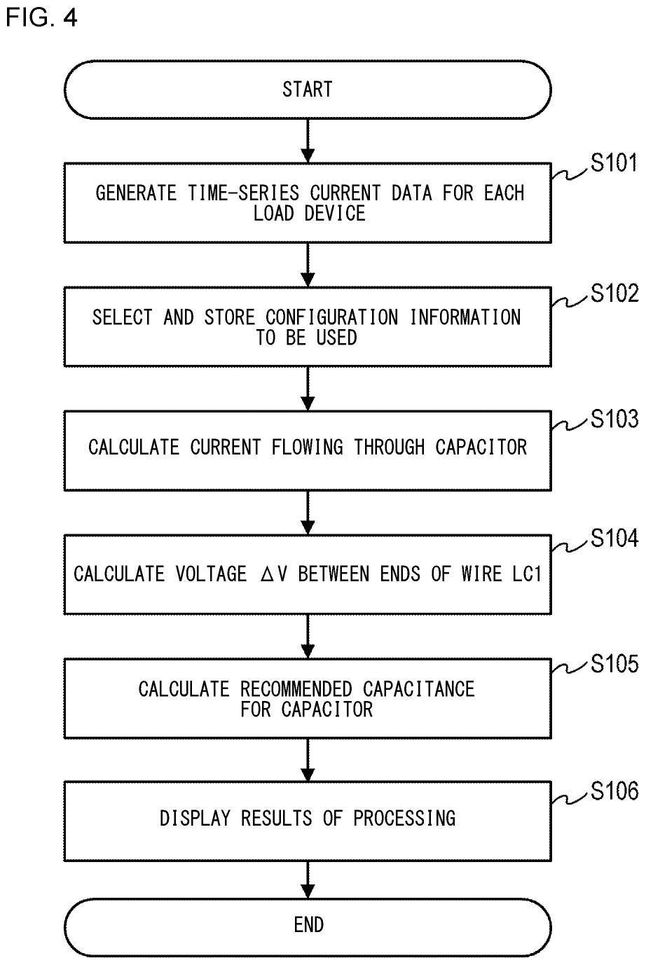

The design assist process performed by the design assist processor 15 will be described with reference to FIG. 4. FIG. 4 is a flowchart of the design assist process. The design assist process includes assisting with designing of the capacitor 25 in the power supply system 1 in the present embodiment.

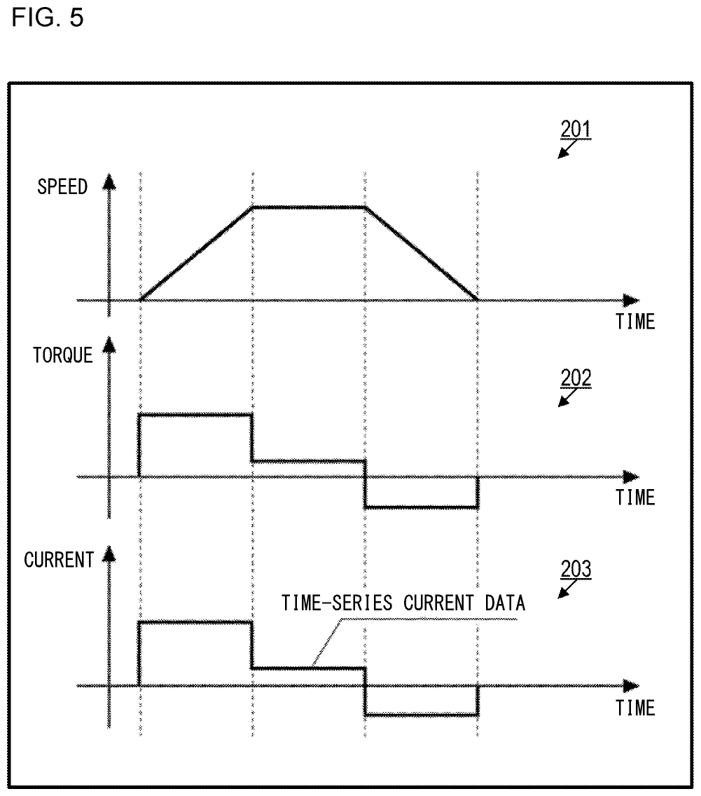

In step S101, the design assist processor 15 generates time-series current data for each load device 40_{X} (1≤X≤N) based on the operation pattern information and the specification information about the load device 40_{X}. An example of processing in step S101 will now be described with reference to FIG. 5. Based on a temporal speed change pattern 201 indicated by the operation pattern information about the load device 40_{X} and the specification information about the load device 40_{X}, the design assist processor 15 calculates a temporal torque change pattern 202 of the electric motor 42_{X}. The design assist processor 15 then generates time-series current data 203 for the load device 40_{X} by dividing the resulting temporal torque change pattern 202 by a preset torque constant of the electric motor 42_{X}.

In step S102, the design assist processor 15 obtains configuration information about the overall configuration of the power supply path 30. The design assist processor 15 may obtain the configuration information from a user input, or may obtain the configuration information prestored in the nonvolatile memory device 17.

In step S103, the design assist processor 15 calculates a current Ic flowing through the capacitor 25 based on a set of the time-series current data and the configuration information about each of the load devices 40.

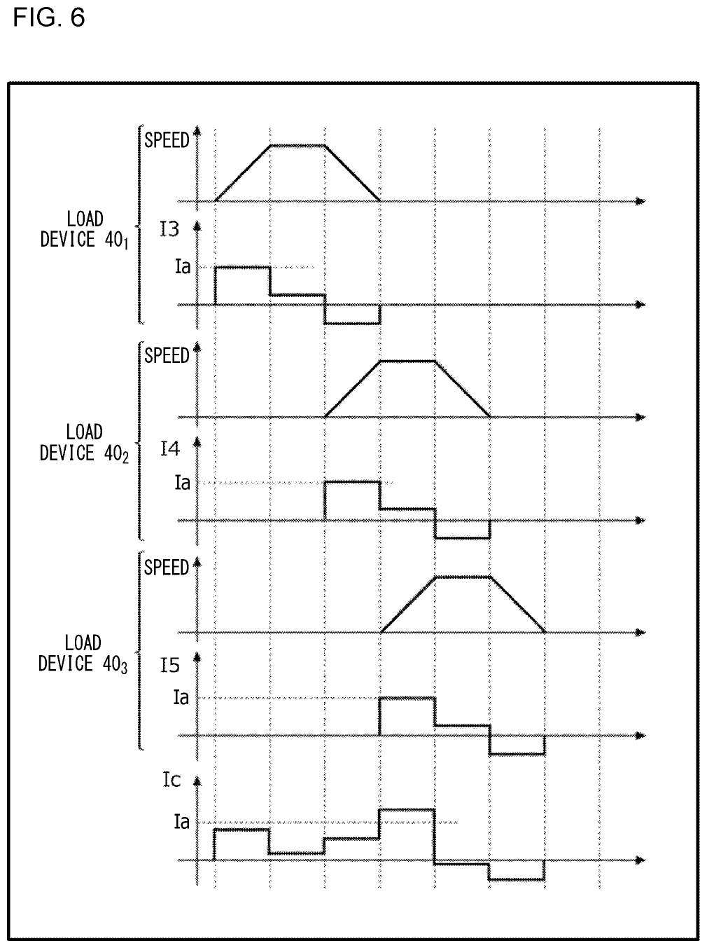

The processing in step S103 in the design assist process will now be described more specifically using the example of the power supply system 1 shown in FIG. 2. FIG. 6 shows temporal changes in the speed of the load devices 40₁ to 40₃ and temporal changes in currents flowing through the load devices 40₁ to 40₃.

In step S103, the design assist processor 15 first adds up the time-series current data about the load devices 40₁ to 40₃ generated in step S101 to generate time-series data about the current I1 flowing through the link cable LC1. In this case, the maximum current value for the link cable LC1 (the maximum value of the current I1) is less than 3×Ia, which is the sum of the maximum values of the time-series current data about the load devices 40₁ to 40₃. The level of a current flowing through the link cable LC1 changes depending on the configuration of the power supply path 30 and thus is to be calculated based on the configuration information and the time-series current data about the load devices 40₁ to 40₃.

The design assist processor 15 then generates time-series data about the current Ic flowing through the capacitor 25 based on the time-series data about the current for the link cable LC1 (current I1) and information about the power supply system 1 (e.g., the supply capacity of the power supply 20, and the voltage used by the inverter 41). The capacitor 25 has the highest request for supplying power when no (zero) power is supplied and received (absorbed) by the power supply 20 and the load devices 40₁ to 40₃ are operating simply with power from the capacitor 25. In such a case, the time-series data about the current for the link cable LC1 (current I1) may be used as the time-series data about the current Ic flowing through the capacitor 25.

The design assist processor 15 then calculates (obtains) the maximum value of the current flowing in a load direction (toward the load device 40) in the time-series data about the calculated current Ic as a maximum power-running current value. The design assist processor 15 also calculates (obtains) the maximum value of the current flowing into the capacitor 25 as a maximum regenerative current. Either the maximum power-running current value or the maximum regenerative current alone may be calculated.

In step S104, the design assist processor 15 calculates a voltage ΔV (maximum voltage) between the ends of the link cable LC1 (a wire commonly connecting the multiple load devices 40 to the capacitor 25) based on the maximum power-running current value or the maximum regenerative current value of the current I1 flowing through the link cable LC1. The maximum power-running current value or the maximum regenerative current value to be calculated may be the greater one of the maximum power-running current value or the maximum regenerative current value. When the internal resistance of the link cable LC1 is R, the voltage ΔV is the product of the current I1 (the maximum power-running current value or the maximum regenerative current value) flowing through the link cable LC1 and the internal resistance R, as written in Formula 1. The maximum power-running current value or the maximum regenerative current value calculated in step S103 may be used in place of the current I1.

ΔV=I1×R Formula 1

The value of the internal resistance R is input by the user in advance and stored as configuration information. When the internal resistance R is not input by the user in advance but the length, the cable diameter, and the resistivity of the link cable LC1 are input in advance as part of configuration information, the design assist processor 15 may calculate the internal resistance R based on the length, the cable diameter, and the resistivity. The processing in step S104 may be skipped when the power supply system 1 includes no link cable LC1 (the configuration information indicates no link cable LC1), as shown in FIG. 3D.

In step S105, the design assist processor 15 calculates an integrated current value based on the time-series data about the current Ic flowing through the capacitor 25 calculated in S103, and uses the integrated current value as a recommended electric charge quantity Q (an electric charge quantity recommended as the charge quantity for the capacitor 25). The design assist processor 15 then calculates a recommended capacitance C for the capacitor 25 (a recommended capacitance for the capacitor 25) based on the recommended electric charge quantity Q.

A method for calculating the recommended electric charge quantity Q and the recommended capacitance C for the capacitor 25 will now be described. With the method described below, the recommended electric charge quantity Q is calculated first. The recommended capacitance C for the capacitor 25 is then calculated based on the recommended electric charge quantity Q. The design assist processor 15 calculates the recommended capacitance C based on the recommended electric charge quantity Q, an initial voltage V0 of the capacitor 25, and an allowable voltage value V1 (allowable voltage) of the capacitor 25. More specifically, as written in Formula 2, the design assist processor 15 calculates the recommended capacitance C as an absolute value of the recommended electric charge quantity Q divided by the value of the initial voltage V0 minus the allowable value V1 (difference between V0 and V1). The initial voltage V0 and the allowable value V1 are input by the user in advance. The initial voltage V0 is a voltage at the initial (starting) point of the overall operation pattern of the load devices 40₁ to 40₃. The allowable value V1 represents the range of voltage variation allowable for the capacitor 25 to maintain the overall operation pattern of the load devices 40₁ to 40₃ and the operation pattern of each of the load devices 40₁ to 40₃. The allowable value V1 may be either the lowest voltage allowable for the capacitor 25 (lowest allowable voltage V1x or the lowest value) or the highest voltage allowable for the capacitor 25 (highest allowable voltage V1y or the highest value) depending on the method used to calculate the recommended electric charge quantity Q. Thus, the recommended electric charge quantity Q will be described, together with whether the lowest allowable voltage V1x or the highest allowable voltage V1y is used as the allowable value V1.

C=|Q/(V0−V1)| Formula 2

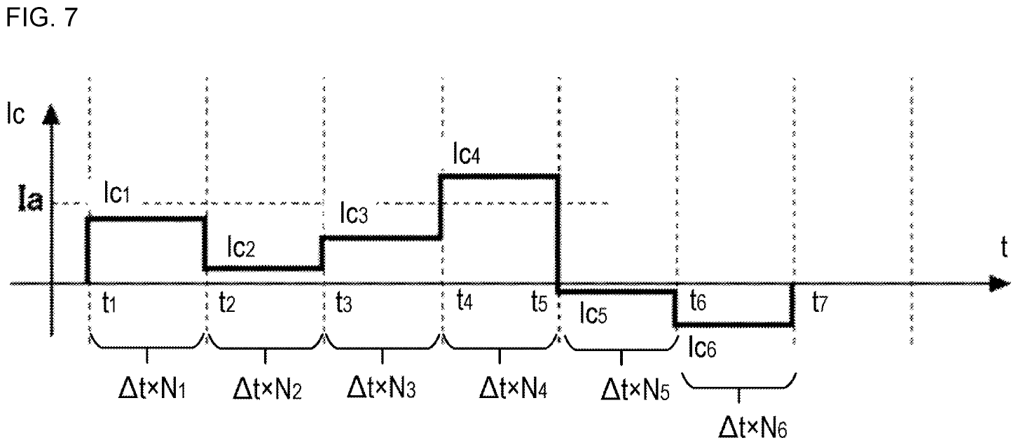

The method for calculating the recommended electric charge quantity Q will now be described with reference to FIG. 7. FIG. 7 is a timing chart describing temporal changes in the current Ic flowing through the capacitor 25 over time t. FIG. 7 shows the temporal changes in the current Ic over one cycle of cyclical change in the current Ic. With the multiple load devices 40₁ to 40₃ operating cyclically in the overall operation pattern, the current Ic cyclically varies to follow the cycle. In FIG. 7, Ic_{X} is a current in the time period from t_{X} to t_{X+1} (X=1 to 6). The interval between time t_{X} and time t_{X+1} is represented as Δt×N_{X}.

(Calculation Example 1 of Recommended Electric Charge Quantity)

In a first calculation example of the recommended electric charge quantity Q, the design assist processor 15 calculates, for example, an integrated value of the current Ic over one cycle period (one cycle of the operation of multiple load devices 40, or the period from t₁ to t₇) as the recommended electric charge quantity Q. In other words, the recommended electric charge quantity Q may be calculated using Formula 3. This allows the capacitor 25 to supply and receive a sufficient level of a current in any period of one cycle of the current Ic. In this case, when the calculated recommended electric charge quantity Q is less than 0 (specifically, the charge quantity during regeneration is greater than the charge quantity during power running), the design assist processor 15 calculates the recommended capacitance C using the highest allowable voltage V1y as the allowable value V1. In this case, when the calculated recommended electric charge quantity Q is less than 0 (specifically, the charge quantity during power running is greater than the charge quantity during regeneration), the design assist processor 15 calculates the recommended capacitance C using the lowest allowable voltage V1x as the allowable value V1.

$$[ Mathematical 1 ]$$

$$\begin{matrix}Q = {\sum }_{k = 1}^{6} ( {I}_{k} \times {N}_{k} ) \times Δ t \\ C = \vert \frac{Q}{V 0 - V 1 y} \vert ( if Q < 0 ) \\ C = \vert \frac{Q}{V 0 - V 1 x} \vert ( if Q > 0 )\end{matrix} \} \qquad Formula 3$$

(Calculation Example 2 of Recommended Electric Charge Quantity)

In a second calculation example of the recommended electric charge quantity Q, the design assist processor 15 may calculate an integrated value of the current from the load devices 40₁ to 40₃ to the capacitor 25 (regenerative current) over one cycle period of the current Ic (integrated value for the period from t₅ to t₇) as the recommended electric charge quantity Q. In other words, the recommended electric charge quantity Q may be calculated using Formula 4. Thus, the recommended electric charge quantity Q can be calculated appropriately when the power supply 20 can supply substantially all the power to the load devices 40₁ to 40₃ and a current is less likely to be provided from the capacitor 25. This also allows the recommended electric charge quantity Q to be smaller than when using the integrated value of the current Ic over one cycle period as the recommended electric charge quantity Q, reducing the recommended capacitance C and thus reducing the size of the capacitor 25. In this case, the design assist processor 15 calculates the recommended capacitance C using the highest allowable voltage V1y as the allowable value V1.

$$[ Mathematical 2 ]$$

$$\begin{matrix}Q = {\sum }_{k = 5}^{6} ( {I}_{k} \times {N}_{k} ) \times Δ t \\ C = \vert \frac{Q}{V 0 - V 1 y} \vert\end{matrix} \} \qquad Formula 4$$

(Calculation Example 3 of Recommended Electric Charge Quantity)

In a third calculation example of the recommended electric charge quantity Q, the design assist processor 15 may calculate an integrated value of the current from the capacitor 25 to the load devices 40₁ to 40₃ (power-running current) over one cycle period of the current Ic (integrated value over the period from t₁ to t₅) as the recommended electric charge quantity Q. In other words, the recommended electric charge quantity Q may be calculated using Formula 5. Thus, the recommended electric charge quantity Q can be calculated appropriately when the capacitor 25 supplies most of the power to the load devices 40₁ to 40₃ during a power-running operation and substantially all the regenerative power is consumable by a regenerative resistor, with a current less likely to be absorbed by the capacitor 25. In this case, the design assist processor 15 calculates the recommended capacitance C using the lowest allowable voltage V1x as the allowable value V1.

$$[ Mathematical 3 ]$$

$$\begin{matrix}Q = {\sum }_{k = 1}^{4} ( {I}_{k} \times {N}_{k} ) \times Δ t \\ C = \vert \frac{Q}{V 0 - V 1 x} \vert\end{matrix} \} \qquad Formula 5$$

(Calculation Example 4 of Recommended Electric Charge Quantity)

In a fourth example calculation of the recommended electric charge quantity Q, the design assist processor 15 may calculate an integrated value of the current Ic over a partial period of one cycle of the current Ic (e.g., the period from t₃ to t₆) as the recommended electric charge quantity Q. In other words, the recommended electric charge quantity Q may be calculated using Formula 6. Thus, when the above partial period is expected to have momentary changes (increases or decreases) in power demanded by the load devices 40₁ to 40₃, for example, the capacitor 25 can appropriately control power in response to such changes in power demand. This sets the recommended capacitance C for the capacitor 25 to a level not more than a limit to accommodate momentary changes in power demand, thus reducing the size of the capacitor 25. In this case, when the calculated recommended electric charge quantity Q is less than 0 (specifically, the charge quantity during regeneration is greater than the charge quantity during power running), the design assist processor 15 calculates the recommended capacitance C using the highest allowable voltage V1y as the allowable value V1. When the calculated recommended electric charge quantity Q is greater than 0, the design assist processor 15 calculates the recommended capacitance C using the lowest allowable voltage V1x as the allowable value V1.

$$[ Mathematical 4 ]$$

$$\begin{matrix}Q = {\sum }_{k = 3}^{5} ( {I}_{k} \times {N}_{k} ) \times Δ t \\ C = \vert \frac{Q}{V 0 - V 1 y} \vert ( if Q < 0 ) \\ C = \vert \frac{Q}{V 0 - V 1 x} \vert ( if Q > 0 )\end{matrix} \} \qquad Formula 6$$

(Calculation Examples 5 and 6 of Recommended Electric Charge Quantity)

In a fifth calculation example of the recommended electric charge quantity Q, the design assist processor 15 may calculate an integrated value Q1 (refer to Formula 5) of the current from the capacitor 25 to the load devices 40₁ to 40₃ (power-running current) and an integrated value Q2 (refer to Formula 4) of the current from the load devices 40₁ to 40₃ to the capacitor 25 (regenerative current) over one cycle period of the current Ic (the period from t₁ to t₇). The design assist processor 15 may then use the greater one of the recommended capacitance C calculated using Formula 4 or the recommended capacitance C calculated using Formula 5. In other words, the recommended capacitance C may be calculated using Formula 7. The design assist processor 15 may use, as the recommended electric charge quantity Q, the greater one of the integrated value of the current (integrated power-running current or integrated regenerative current) corresponding to either the recommended capacitance C calculated using Formula 4 or the recommended capacitance C calculated using Formula 5. The function Max herein is a function that returns an argument of the greatest value of multiple arguments. In a sixth calculation example of the recommended electric charge quantity Q, the design assist processor 15 may calculate an integrated value Q1 of the power-running current and an integrated value Q2 of the regenerative current over a partial period of one cycle of the current Ic (e.g., the period from t₃ to t₆). In other words, the recommended capacitance C may be calculated using Formula 8. In this case, the recommended capacitance C is the greater one of a value calculated using Formula 9 (described later) or a value calculated using Formula 10 (described later). When the capacitor 25 supplies most of the power to the load devices 40₁ to 40₃, the recommended electric charge quantity Q can be calculated appropriately.

$$[ Mathematical 5 ]$$

$$\begin{matrix}Q 1 = {\sum }_{k = 1}^{4} ( {I}_{k} \times {N}_{k} ) \times Δ t , Q 2 = {\sum }_{k = 5}^{6} ( {I}_{k} \times {N}_{k} ) \times Δ t \\ C = Max ( \vert \frac{Q 1}{V 0 - V 1 x} \vert , \vert \frac{Q 2}{V 0 - V 1 y} \vert )\end{matrix} \} \qquad Formula 7$$

$$\begin{matrix}Q 1 = {\sum }_{k = 3}^{4} ( {I}_{k} \times {N}_{k} ) \times Δ t , Q 2 = {\sum }_{k = 5}^{5} ( {I}_{k} \times {N}_{k} ) \times Δ t \\ C = Max ( \vert \frac{Q 1}{V 0 - V 1 x} \vert , \vert \frac{Q 2}{V 0 - V 1 y} \vert )\end{matrix} \} \qquad Formula 8$$

(Calculation Examples 7 and 8 of Recommended Electric Charge Quantity)

In a seventh calculation example of the recommended electric charge quantity Q, the design assist processor 15 may calculate an integrated value of the power-running current over a partial period of one cycle of the current Ic (e.g., the period from t₃ to t₆) as the recommended electric charge quantity Q. In other words, the recommended electric charge quantity Q may be calculated using Formula 9. In this case, the design assist processor 15 calculates the recommended capacitance C using the lowest allowable voltage V1x as the allowable value V1. In an eighth calculation example of the recommended electric charge quantity Q, the design assist processor 15 may calculate an integrated value of the regenerative current over a partial period of one cycle of the current Ic as the recommended electric charge quantity Q. In other words, the recommended electric charge quantity Q may be calculated using Formula 10. In this case, the design assist processor 15 calculates the recommended capacitance C using the highest allowable voltage V1y as the allowable value V1.

$$[ Mathematical 6 ]$$

$$\begin{matrix}Q = {\sum }_{k = 3}^{4} ( {I}_{k} \times {N}_{k} ) \times Δ t \\ C = \vert \frac{Q}{V 0 - V 1 x} \vert\end{matrix} \} \qquad Formula 9$$

$$\begin{matrix}Q = {\sum }_{k = 5}^{5} ( {I}_{k} \times {N}_{k} ) \times Δ t \\ C = \vert \frac{Q}{V 0 - V 1 y} \vert\end{matrix} \} \qquad Formula 10$$

The design assist processor 15 may correct (calculate) the allowable value V1 using the voltage ΔV between the ends of the link cable LC1 (the wire connecting the capacitor 25 and the load devices 40) calculated in step S104. More specifically, the design assist processor 15 may update the allowable value V1 by adding the voltage ΔV to the above allowable value V1 (the allowable value input by the user). Thus, the recommended capacitance C can be calculated to reflect the power consumption in the link cable LC1, allowing the recommended capacitance C to be calculated appropriately when the internal resistance of the link cable LC1 is large.

In step S106, the design assist processor 15 displays (outputs) the result of processing or information about the current Ic flowing through the capacitor 25 and the recommended capacitance C for the capacitor 25 on the display 12. The information about the current Ic may be displayed as a graph showing the time-series current data about the current Ic, or as the maximum power-running current value, the maximum regenerative current value, or both the values calculated in step S104. The design assist processor 15 may further display (output) information about the recommended electric charge quantity Q on the display 12.

Thus, in step S106, the current Ic flowing through the capacitor 25 and the recommended capacitance C for the capacitor 25 are displayed. The recommended capacitance C is calculated from the integrated value of the current Ic flowing through the capacitor 25, thus reducing the possibility of the capacitor 25 having an unintended capacitance. Thus, the user can design the power supply system 1 with the capacitor 25 with appropriate specifications based on the information displayed on the screen of the display 12.

In step S106, the design assist processor 15 may simply display, on the display 12, information about the recommended capacitance C but no information about the current Ic for the user who is to be informed simply of the capacitance recommended for the capacitor 25. The design assist processor 15 may notify the user of (or may output) information about the current Ic and the recommended capacitance C by voice, instead of displaying the information on the display 12. The design assist processor 15 may also output information about the current Ic and the recommended capacitance C to, for example, an external device (e.g., a printer or a smartphone) through a network.

In the above examples, the recommended capacitance C for the capacitor 25 is calculated and displayed for a single power supply system 1. However, for example, a user may intend to identify the recommended capacitance C for the capacitor 25 in each of the four power supply systems 1 shown in FIGS. 3A to 3D. In this case, the design assist processor 15 may perform the design assist process for each of the four power supply systems 1 (for each of the four sets of configuration information). In this case, the user inputs configuration information into the design assist device 10 for each of the three power supply systems 1.

The design assist device 10 (the UI processor 14 and the design assist processor 15) according to the present embodiment has the above functions. The design assist device 10 allows designing of the power supply system 1 with the capacitor 25 with appropriate specifications.

In the present embodiment, all the processes in the flowchart are performed by the design assist processor 15, but may be performed by multiple components in a shared manner. For example, a calculator (not shown) may perform steps S101 to S105, and an output unit (not shown) may output the information to be displayed on the display 12 in step S106.

<Modifications>

The design assist device 10 according to the above embodiment may be modified variously. In one modification, for example, the design assist device 10 may be a device for assisting with designing of a power supply system 1 in which each load device 40 includes a servo driver in place of the inverter 41 and the power supply 20 is a DC power supply. The power supply 20 in the power supply system 1 may combine outputs from multiple power supplies (e.g., AC-DC converters and batteries) connected in parallel.

In the embodiment described above, the recommended capacitance C for the capacitor 25 is calculated in step S105 to reflect the voltage ΔV between the ends of the link cable LC1. When the power supply system 1 is a distributed system, the design assist processor 15 may calculate the recommended capacitance C for the capacitor 25 to further reflect the voltage generated by the internal resistance of each of the link cables LC2 to LC5. The power supply system 1 being a distributed system refers to a system including the link cables LC2 to LC5 including at least one cable not shorter than a predetermined length (e.g., 1 m). In such cases, the voltage generated by the internal resistance of the link cables LC2 to LC5 is not negligible for the entire power supply system 1.

In such cases, as in the above step S104, the design assist processor 15 calculates the maximum voltage generated by the internal resistance of each of the link cables LC2 to LC5 from the maximum current value (maximum power-running power value or the maximum regenerative power value) and the internal resistance in each of the link cables LC2 to LC5. In step S105, the design assist processor 15 then corrects (calculates) the allowable value V1 based on the voltage ΔV and the maximum voltage generated by the internal resistance of each of the link cables LC2 to LC5. In the example of FIG. 2, the design assist processor 15 calculates the voltage generated by the internal resistance of each of the link cables LC2 to LC5. The design assist processor 15 then adds, to the allowable value V1, the maximum voltage generated between the connector CN1 connecting link cables and each of the load devices in each of the structures in FIGS. 3A to 3D. Thus, an appropriate recommended capacitance C for the capacitor 25 can be calculated in distributed systems as well. The values of the internal resistance and the length of each link cable are input by the user in advance and stored as configuration information. When the power supply system 1 is not a distributed system, the design assist processor 15 may neglect the voltage generated by the internal resistance of each of the link cables LC2 to LC5 to prevent an increase in the volume of processing performed by the design assist processor 15.

The design assist device 10 may be modified to assist with designing of a power supply system 1 with the structure shown in FIG. 8, in which multiple capacitors 25 (25a and 25b in FIG. 8) supply and distribute power to multiple load devices 40. In such a modification of the design assist device 10, when a power supply path 30 is determined to include multiple capacitors 25 in analyzing the configuration information, the configuration information and the operation pattern information may be divided, for the respective capacitors 25, into information sets, with each of which the above design assist process may be performed. In the power supply system 1 with the configuration shown in FIG. 8, the information sets for the capacitors 25 include a set for a capacitor 25a including configuration information about the configuration of a power supply path 30a and operation pattern information about load devices 40₁ to 40₃, and a set for a capacitor 25b including configuration information about the configuration of a power supply path 30b and operation pattern information about load devices 40₄ to 40₆.

The design assist device 10 described above may be modified to eliminate some of the functions, or to input and output information through a network (in other words, a device including neither the input device 11 nor the display 12).

### Appendix 1

A design assist device (10) for assisting with designing of a power supply system (1) to supply and distribute power from a power supply (20) and a capacitor (25) connected parallel to each other to a plurality of load devices (40) through a power supply path (30) combining a plurality of power cables, the design assist device (10) comprising:
a first obtainer (14) configured to obtain configuration information representing an overall configuration of the power supply path (30);
a second obtainer (15) configured to obtain operation pattern information representing an operation pattern of each of the plurality of load devices (40);
a calculator (15) configured to calculate time-series data about a current flowing through the capacitor (25) based on the configuration information obtained by the first obtainer and the operation pattern information about each of the plurality of load devices (40) obtained by the second obtainer (25), and calculate, based on the time-series data about the current, a recommended capacitance being a capacitance recommended for the capacitor (25); and
an outputter (15) configured to output at least information about the recommended capacitance for the capacitor.

### REFERENCE SIGNS LIST

1; power supply system, 10; design assist device, 11; input device, 12; display, 13; main unit, 14; UI processor, 15; design assist processor, 16; design assist program, 17; nonvolatile memory device, 18; grid, 20; power supply, 22; converter, 25; capacitor, 30; power supply path, 40; load device, 41; inverter, 42; electric motor, 43; load machine

1. A design assist device for assisting with designing of a power supply system to supply and distribute power from a power supply and a capacitor connected parallel to each other to a plurality of load devices through a power supply path combining a plurality of power cables, the design assist device comprising:
a first obtainer configured to obtain configuration information representing an overall configuration of the power supply path;
a second obtainer configured to obtain operation pattern information representing an operation pattern of each of the plurality of load devices;
a calculator configured to calculate time-series data about a current flowing through the capacitor based on the configuration information obtained by the first obtainer and the operation pattern information about each of the plurality of load devices obtained by the second obtainer, and calculate, based on the time-series data about the current, a recommended capacitance being a capacitance recommended for the capacitor; and
an outputter configured to output at least information about the recommended capacitance for the capacitor.

2. The design assist device according to claim 1, wherein
the power supply system includes the power supply being a direct current power supply, and the plurality of load devices each including a load machine, an electric motor configured to drive the load machine, and an inverter configured to control the electric motor,
the second obtainer obtains a set of command values to be input into the inverter in chronological order as the operation pattern information about each of the plurality of load devices when each of the plurality of load devices is operated, and
the calculator generates time-series data about the current flowing into each of the plurality of load devices based on the operation pattern information about each of the plurality of load devices and calculates the time-series data about the current flowing through the capacitor based on the time-series data generated for each of the plurality of load devices and the configuration information.

3. The design assist device according to claim 2, wherein
the calculator calculates at least one of a maximum value of a current flowing from the capacitor or a maximum value of a current flowing into the capacitor as a maximum current value of the capacitor based on the time-series data for each of the plurality of load devices and the configuration information, and
calculates the recommended capacitance for the capacitor based on the time-series data about the current flowing through the capacitor and the maximum current value.

4. The design assist device according to claim 1, wherein
the calculator calculates, as an electric charge quantity recommended for the capacitor, an integrated value of a current in a predetermined period based on the time-series data about the current flowing through the capacitor, and
calculates the recommended capacitance for the capacitor as the electric charge quantity divided by a difference between an allowable voltage and an initial voltage of the capacitor, and
the allowable voltage is a voltage value in a range of voltage variation allowable for the capacitor to maintain the operation pattern of each of the plurality of load devices.

5. The design assist device according to claim 4, wherein
the calculator calculates an integrated value of a current flowing into the capacitor or an integrated value of a current flowing from the capacitor in the predetermined period as the electric charge quantity.

6. The design assist device according to claim 4, wherein
the calculator calculates the recommended capacitance as the electric charge quantity divided by a difference between a lowest value or a highest value of the range of voltage variation allowable for the capacitor and the initial voltage of the capacitor.

7. The design assist device according to claim 6, wherein
the calculator calculates the recommended capacitance as the electric charge quantity divided by a difference between the lowest value of the range of voltage variation allowable for the capacitor and the initial voltage of the capacitor when the electric charge quantity is positive, and
calculates the recommended capacitance as the electric charge quantity divided by a difference between the highest value of the range of voltage variation allowable for the capacitor and the initial voltage of the capacitor when the electric charge quantity is negative.

8. The design assist device according to claim 6, wherein
the calculator calculates an integrated value of a current flowing into the capacitor and an integrated value of a current flowing from the capacitor in the predetermined period, and
calculates the recommended capacitance for the capacitor using a greater value of the integrated value of the current flowing into the capacitor divided by the difference between the highest value of the range of voltage variation allowable for the capacitor and the initial voltage of the capacitor, or the integrated value of the current flowing from the capacitor divided by the difference between the lowest value of the range of voltage variation allowable for the capacitor and the initial voltage of the capacitor.

9. The design assist device according to claim 4, wherein
the plurality of load devices operate cyclically, and
the predetermined period is a period of a cycle of an operation of the plurality of load devices or a partial period of the cycle.

10. The design assist device according to claim 4, wherein
the plurality of power cables include a first power cable commonly connecting the plurality of load devices to the capacitor, and the calculator calculates the allowable voltage based on a voltage generated by an internal resistance of the first power cable.

11. The design assist device according to claim 4, wherein
the calculator calculates the allowable voltage based on a voltage generated by an internal resistance of each of the plurality of power cables.

12. The design assist device according to claim 1, wherein
the outputter suggests, to a user, using a branch connector incorporating the capacitor to distribute and supply power to each of the plurality of load devices from the power supply and the capacitor.

13. A non-transitory computer readable medium storing a design assist program for causing a computer to operate as the design assist device according to claim 1.
